(19) United States
(12) Patent Application Publication
(10) Pub. No.: US 2013/0247533 A1
(43) Pub. Date: Sep. 26, 2013

(54) Landscape And Construction Tool With Multiple Heads

(71) Applicant: Andy T. Zupan, Oklahoma City, OK (US)

(72) Inventor: Andy T. Zupan, Oklahoma City, OK (US)

(21) Appl. No.: 13/834,197

(22) Filed: Mar. 15, 2013

Related U.S. Application Data
(60) Provisional application No. 61/615,343, filed on Mar. 25, 2012.

(51) Int. Cl. A01D 11/06; A01D 7/00

(52) U.S. Cl. CPC A01D 11/06; A01D 7/00
USPC 56/400.04; 56/400.01

(57) ABSTRACT

A landscaping tool comprising a rigid shaft having a proximal and distal end and presenting a central axis, a rake head having a rake base, and a plurality of tines extending outwardly from the rake base. The rake head is oriented from about 90° to 120° relative to said central axis. A brace comprises two arms, each of the arms joined to the head at opposing sides and extending from the head and converging at the shaft. The device optionally further comprises additional heads.

### PRIORITY

The present invention claims priority to provisional application 61/615,343, which has a filing date of Mar. 25, 2012, which is hereby incorporated by reference.

### BACKGROUND

1. Field of the Invention

The present invention relates to a device for use in landscaping and construction, more specifically to a device with multiple heads for use in landscaping and construction.

2. Description of the Related Art

Property owners and landscape companies must spend a significant amount of time maintaining the lawn, landscape, and garden. Some of the tasks include mowing, sweeping, raking. A significant part of this effort includes raking, sweeping, edging, mulching, weeding, digging, and cleanup. Those tasks can involve repetitive motion in sustained or awkward positions.

Furthermore, each of the tasks can require a separate tool, with each tool requiring additional space. Several tools may be suspended from a wall of a shed, but they still consume unnecessary, significant storage space. Moreover, a significant part of the landscaping effort requires walking back and forth to retrieve the different tools, consuming time and energy.

A push broom having a wooden handle with a threaded end for attachment to broom head with corresponding interior threads for receipt of the broom handle is known in the art, but it has limited configurability, function, durability, and ergonomics.

For the above reasons, it would be advantageous to have a landscaping tool with multiple heads, which is durable and configurable to enable fast, comfortable, and efficient use.

### SUMMARY

A landscaping tool comprising a rigid shaft having a proximal and distal end and presenting a central axis, a rake head having a rake base, and a plurality of tines extending outwardly from the rake base. The rake head is oriented from about 90° to 120° relative to said central axis. A brace comprises two arms, each of the arms joined to the head at opposing sides and extending from the head and converging at the shaft. The device optionally further comprises additional heads.

These and other features, aspects, and advantages of the invention will become better understood with reference to the following description, and accompanying drawings.

### BRIEF DESCRIPTION OF THE DRAWINGS

FIG. 1 depicts a side perspective view of an embodiment of the current invention with rake and broom heads;

FIG. 2 depicts a side view of the embodiment of FIG. 1;

FIG. 3 depicts a partial side view of the embodiment of FIG. 1;

FIG. 4 depicts a partial bottom view of the embodiment of FIG. 1;

FIG. 5 depicts a partial side view of the embodiment of FIG. 1;

FIG. 6 depicts a partial top view of the embodiment of FIG. 1;

FIG. 7 depicts a side perspective view of an alternate embodiment of the current invention;

FIG. 8 depicts a side perspective view of another alternate embodiment of the current invention;

FIG. 9 depicts a partial alternative side perspective view of the embodiment of FIG. 8;

FIG. 10 depicts a side perspective view of another alternate embodiment of the current invention;

FIG. 11 depicts an alternate partial side perspective view of the embodiment of FIG. 10; and

FIG. 12 depicts a top view of the embodiment of FIG. 10.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

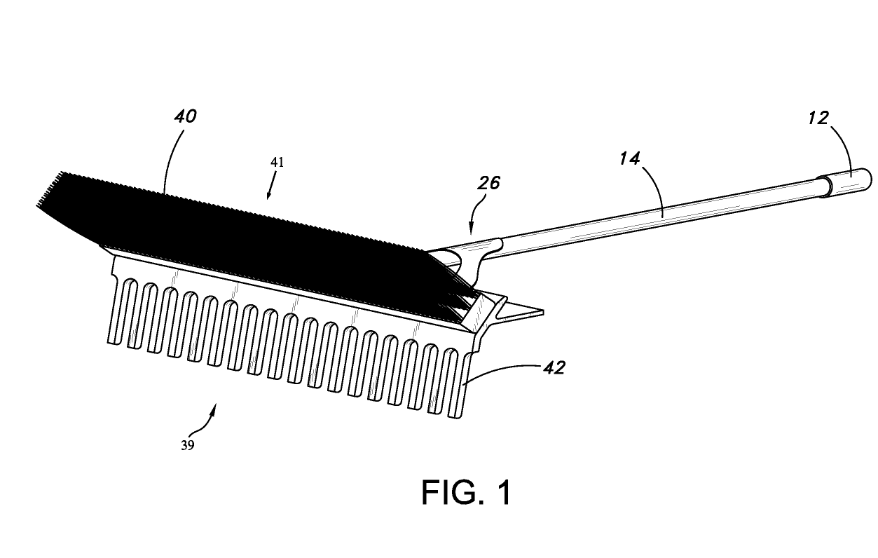

The present invention is directed to a device for use in lawn maintenance, garden maintenance, and construction in commercial or residential settings such as, but not limited to, raking, sweeping, edging, mulching, weeding, digging, cleanup, excavation, digging, leveling, and smoothing. FIG. 1 illustrates a multiple head landscaping tool 10. The device includes a handle 12, a shaft 14, a brace 26, and plural head members 39 41.

The shaft 14 is a rigid member having a proximal end and a distal end. It is composed of durable materials such as metal, plastic, composites, or the like. It is preferably tubular shaped and optionally includes a handle 12 at its proximal end operable as a gripping surface. The shaft 14 presents a central axis 13 extending longitudinally through its length and extending past its distal end.

The shaft 14 is joined to at least one head 39 41 63, where each head is operable to perform select landscaping, garden, yard, and construction functions. The exemplary landscape tool 10 includes two heads 39 41 63. The heads 39 41 63 oriented in a spaced apart, angular relationship where the configured orientations include the angle of the head 39 41 63 relative to the ground during use, the angle of the head 39 41 63 relative to the shaft 14, the angle of a first head 39 41 63 relative angle to a second head 39 41 63. In order to optimize function, durability, and ergonomics, each landscaping tool 10 embodiment's head's angles are selectively configured. The body of each head 39 41 63 is substantially linear and perpendicular to the shaft 14 when attached.

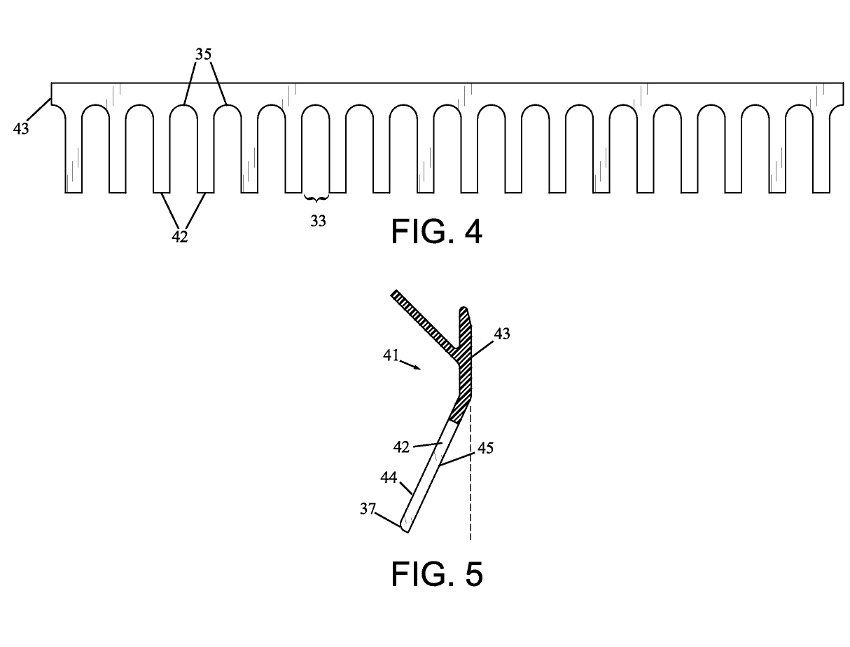

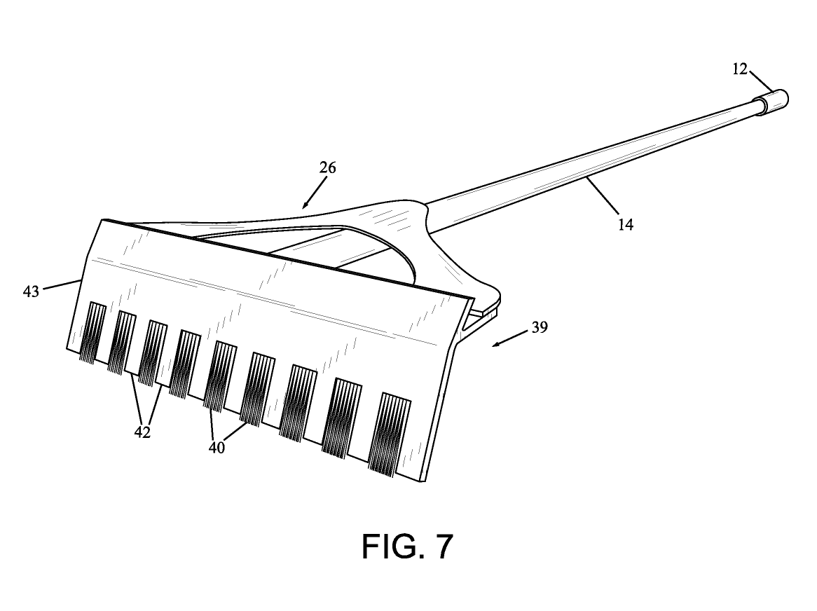

Having disclosed the general principal of the heads 39 41 63, different head configurations will be disclosed. FIGS. 1-3 illustrate an embodiment incorporating a rake head 41. As shown in FIG. 4, the rake head 41 includes a rake base 43 and a plurality of tines 42. The rake base 43 extends laterally with spaced apart tines 42 extending outwardly from the rake base 43. In exemplary configuration, the tine to tine spacing 33 is consistent from the top end of the tine 42 to the tip of the tine 42. The rake base 43 optionally includes a recessed arc region 35 between the tines 42. As shown in FIG. 5, the tines 42 has a front face 44, a rear 45. The tines 42 preferably incorporate a curvilinear tip 37 on their front faces 44. Optionally, the tines 42 are angled slightly acute from the rake base 43. In the configuration of FIG. 7, bristles 40 of similar length to the tines 42 extend outwardly from the rake base 43 interposed with the tines 42.

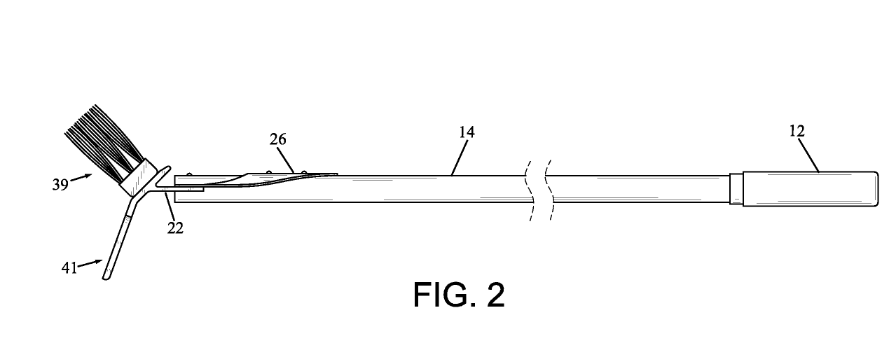

FIG. 2 illustrates a broom head 39 having a broom base 27 extending laterally with bristles 40 extending outwardly along the length of the broom base 27.

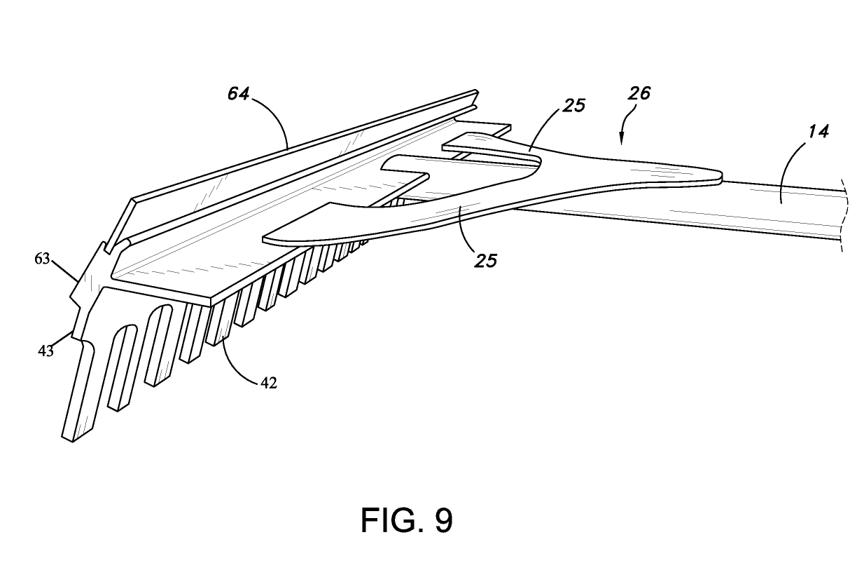

FIG. 9 illustrates a squeegee head 63 having a squeegee base 61 extending laterally securing a flexible blade 64. The blade 64 extends outwardly from the squeegee base 61 along the length of the squeegee base 61.

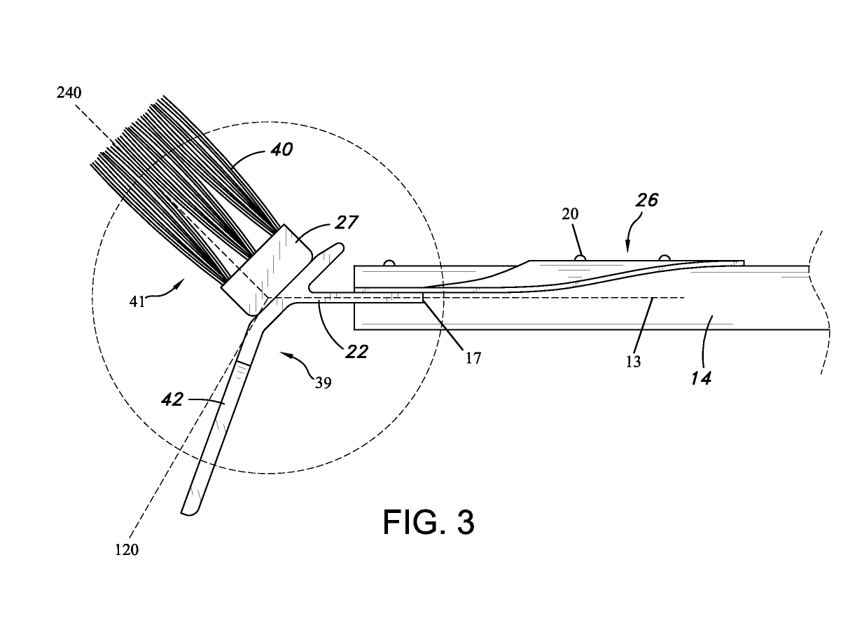

Having disclosed the head 39 41 63 configurations, multiple landscape tool 10 embodiments incorporating the heads 39 41 63 will be disclosed. FIG. 1 discloses a landscape tool 10 having a rake head 39 and a broom head 41 joined lengthwise with the heads 39 41 disposed in an angular relationship relative to each other and the axis 13 presented by the handle 14. FIG. 3 depicts the exemplary configuration of this embodiment. In it, the rake head 39 is oriented at about 110° relative to the axis of the handle 14 and the broom head 41 is oriented at about 240° relative to the axis of the handle 14. In an alternate configuration, the rake head 39 is oriented from about 120° to about 90° relative to the axis of the handle 14 and the broom head 41 is oriented from about 240° to about 270° relative to the axis of the handle 14.

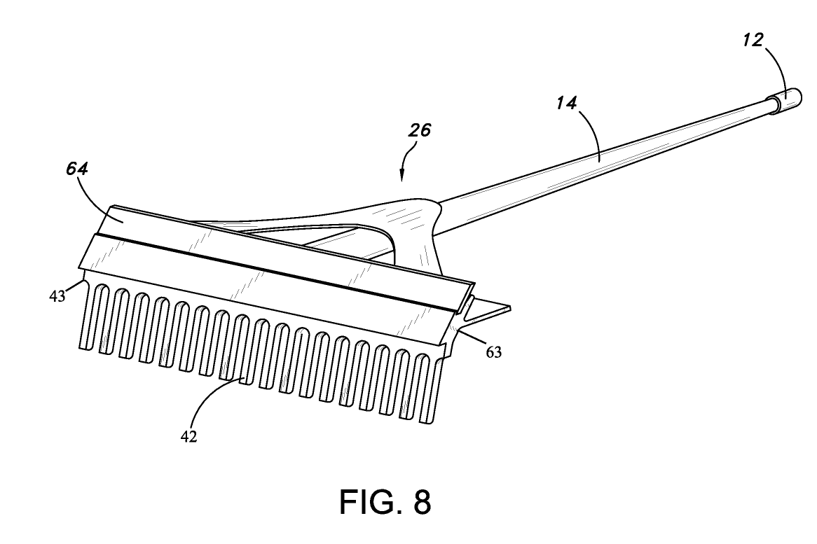

FIGS. 8 and 9 disclose a landscape tool 10 having a rake head 39 and a squeegee head 63 joined lengthwise with the heads 39 63 disposed in an angular relationship relative to each other and the axis 13 presented by the handle 14. FIG. 9 depicts the exemplary configuration of this embodiment. In it, the rake head 39 is oriented at about 110° relative to the axis of the handle 14 and the squeegee head 63 is oriented at about 240° relative to the axis of the handle 14. In an alternate configuration, the rake head 39 is oriented from about 120° to about 90° relative to the axis of the handle 14 and the squeegee head 63 is oriented from about 240° to about 270° relative to the axis of the handle 14.

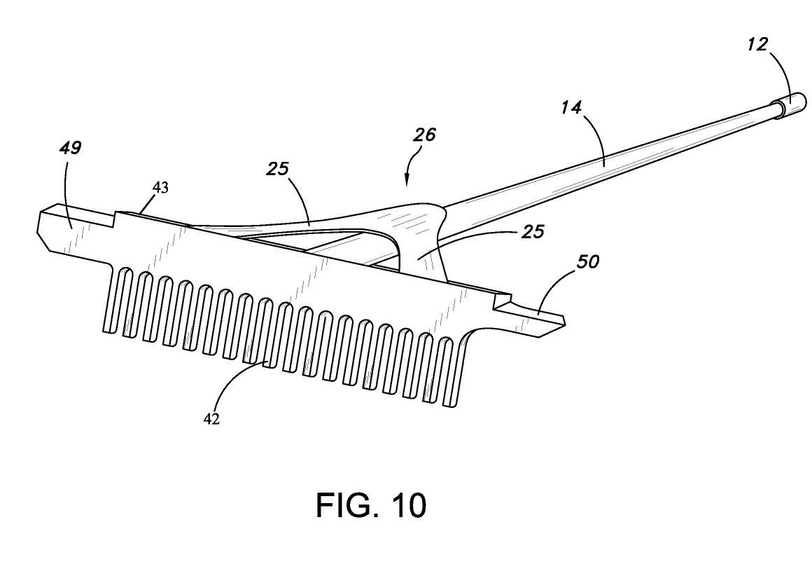

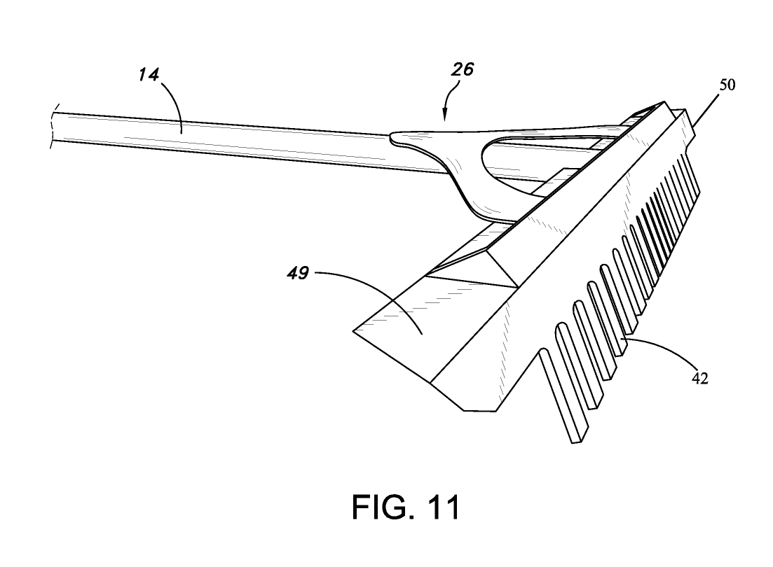

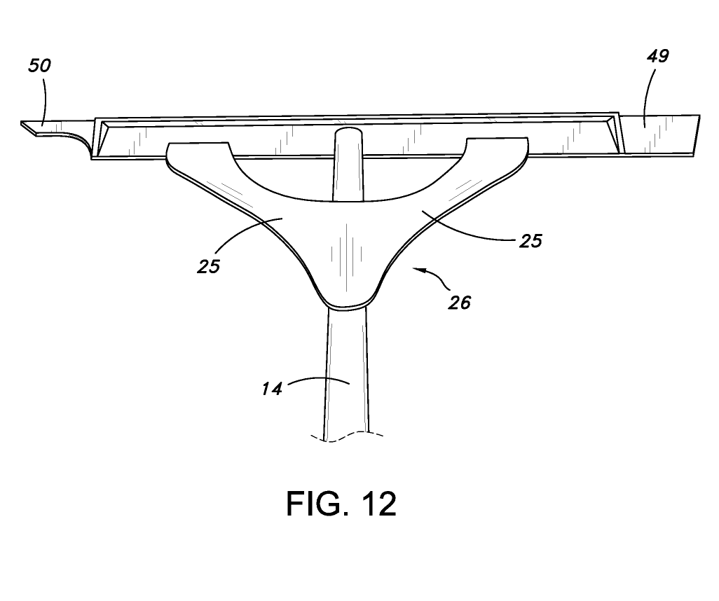

FIGS. 10 and 11 disclose a landscape tool 10 having a rake head 39, hoe blade 49, and a pick blade 50. In the exemplary configuration of this embodiment, the rake head 39 is oriented at about 110° relative to the axis of the handle 14. In an alternate configuration, the rake head 39 is oriented from about 120° to about 90° relative to the axis of the handle 14. The wider hoe blade 49 preferably extends from a first end of the rake head 39 substantially orthogonally to the handle 14. The more narrow pick blade 50 preferably extends from the opposing end of the rake head 39 substantially orthogonally to the handle 14.

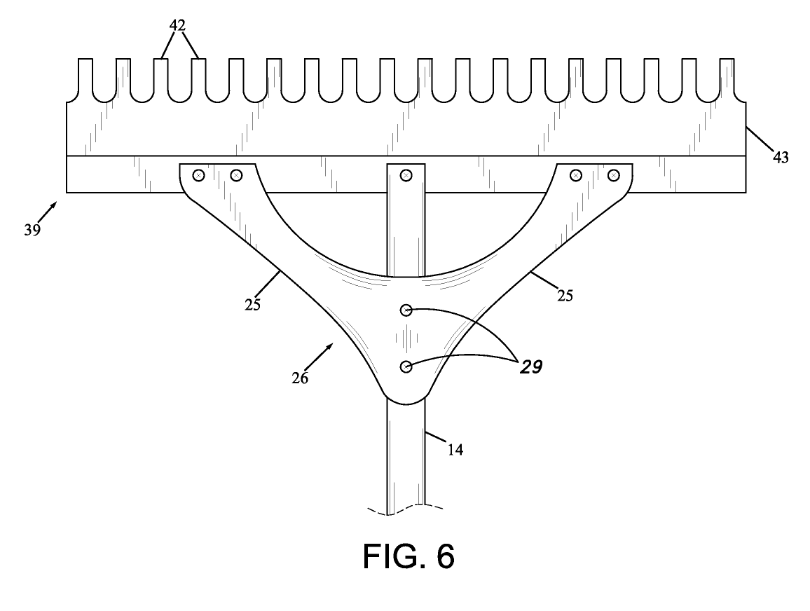

The heads 39 41 63 are secured to the handle 14 with a brace 26. As shown in the configuration of FIG. 6, the illustrated brace 26 has two arms 25, each extending from opposing sides of the head 39 41 63. Each arm 25 extends from the head 39 41 63 and the two arms 25 converge at the handle 14. The brace 26 optionally includes a bore 29 where mechanical fasteners, such as a locking pin 20, are used to secure the handle 14 to the head 39 41 63.

Referring to FIG. 2, the landscaping tool 10 optionally includes a locking structure for secure, detachable joining head members to the shaft 14. In the illustrated embodiments, part of the locking structure is incorporated in the shaft 14 and part in the head 39 41 63. At its distal end the shaft 14 includes a slot 17, preferably planar and spanning the width of the shaft 14. The depth of the slot 17 is configured to provide lateral stability to a head member attached therein. The shaft 14 also includes at least one aperture 18 extending through it and the slot 17. The head 39 41 63 has a locking tab 22, preferably planar and extending distally to the base 38 43, operable to slidably mate with the slot 17 of the shaft 14. Its width and length should be about that of the corresponding slot 17 in the shaft 14. The locking tab 22 also includes an opening towards its upper end, such that upon mating with the slot 17 of the shaft 14, the aperture of the shaft 14 aligns with the opening of the locking tab 22, forming a complete channel. A locking pin 20 or similar fastener can be inserted therethrough to secure the head 39 41 63 to the shaft 14.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A landscaping tool comprising:
a rigid shaft having a proximal and distal end and presenting a central axis;
a rake head having a rake base, a plurality of tines extending outwardly from said rake base, said rake head oriented from about 90° to 120° relative to said central axis, said shaft joined to central region of said head;
a brace comprised of two arms, each of said arms joined to said head at opposing sides and extending from the head and converging at the shaft.

2. The device of claim 1 wherein said rake head is oriented at about 110° relative to said central axis.

3. The device of claim 1 wherein said tines further comprise a front face having a curvilinear tip.

4. The device of claim 1 wherein said rake base further comprises recessed regions disposed between said tines.

5. The device of claim 1 further comprising bristles interposed between said tines.

6. The device of claim 1 further comprising a broom head, said broom head comprising a broom base with bristles extending outwardly from said broom base, said broom head oriented from about 220° to 320° relative to said central axis.

7. The device of claim 1 further comprising a broom head, said broom head comprising a broom base with bristles extending outwardly from said broom base, said broom head oriented from about 240° to 270° relative to said central axis.

8. The device of claim 6 wherein said broom head is oriented about 240° relative to said central axis.

9. The device of claim 1 further comprising a squeegee head, said squeegee head comprising a squeegee base securing a blade extending outwardly from said squeegee base, said broom head oriented from about 220° to 320° relative to said central axis.

10. The device of claim 1 further comprising a squeegee head, said squeegee head comprising a squeegee base securing a blade extending outwardly from said squeegee base, said broom head oriented from about 240° to 270° relative to said central axis.

11. The device of claim 8 wherein said squeegee head is oriented about 240° relative to said central axis.

12. The device of claim 1 further comprising a hoe blade extending laterally from a side of said rake head.

13. The device of claim 10 further comprising a pick blade extending laterally from the second side of said rake head.

14. The device of claim 1 further comprising a pick blade extending laterally from a side of said rake head.

15. The device of claim 1 wherein said shaft further comprises a slot in its distal end and the head further comprises a locking tab operable to slideably engage to said slot.

16. The device of claim 1 wherein the tine to tine spacing is similar from the top end of said tines to the tip of said tines.
